(19) United States
(12) Patent Application Publication
(10) Pub. No.: US 2019/0354349 A1
(43) Pub. Date: Nov. 21, 2019

(54) METHOD FOR EXPANDING THE CONTENT IN A DOCUMENT AND METHOD FOR PROBLEM FORMULATION

(71) Applicant: MEMS Start, LLC, Arcadia, CA (US)

(72) Inventors: Roman C. Gutierrez, Arcadia, CA (US); Tony Tang, Arcadia, CA (US)

(21) Appl. No.: 16/413,585

(22) Filed: May 15, 2019

Related U.S. Application Data
(60) Provisional application No. 62/671,946, filed on May 15, 2018.

(51) Int. Cl. G06F 8/20; G06F 16/93

(52) U.S. Cl. CPC G06F 8/20; G06F 16/93

(57) ABSTRACT

Systems and methods are provided for extracting engineering data from a technical document. The extracted data may be used by a software application to generate new technical data. Both original and new technical data may be stored in a data source and can be queried by using a set of design specifications.

### CROSS-REFERENCE TO RELATED APPLICATIONS

This application claims the benefit of U.S. Provisional Patent Application Ser. No. 62/671,946 filed May 15, 2018, which is incorporated herein by reference in its entirety.

### TECHNICAL FIELD

The present disclosure is generally related to searching engineering. More particularly, the present disclosure is directed to systems and methods that use extracted engineering data in a plurality of software applications to generate new designs which can be used for searching specific designs.

### BACKGROUND

A patentability search is conducted by examining existing publications that relate to an inventor's idea in an effort to determine whether the idea has already been described. By viewing similar inventions, inventor can improve and refine his or her design without infringing on someone else's rights. This practice also allows the inventor to avoid investing significant resources into an idea that you cannot be patented.

To date, the best and most thorough searches are performed by searching patent applications and other technical papers, articles and publications containing information about engineering and product design. However, searching for the right invention is complex and time consuming. The United States Patent and Trademark Office alone has issued over ten million patents. Further, companies all over the world spend over one trillion dollars annually on research and development. This continued generation of new ideas makes a comprehensive search daunting if not impossible.

### SUMMARY

In accordance with one or more embodiments, various features and functionality can be provided to enable or otherwise facilitate a functional search of engineering data.

In some embodiments, a technical document comprising an engineering design may be analyzed to extract a set of design component parameters. In some embodiments, a data file compatible with a particular design software application may be generated from the extracted set of design component parameters.

In some embodiments, the software application may use the generated data file to test or simulate the disclosed design under various conditions. In some embodiments, the software application may generate new design data representing original technical data under a number of simulated conditions. In some embodiments, the new design data may comprise a second set of design parameters.

In some embodiments, the data extracted from the technical document and the new data representing simulated data generated by the software application may be used to populate a database. For example, data representing design components may be stored within design nodes of a design cluster of a graph database, while data representing design component parameters may be stored within specification nodes of a specification cluster. In some embodiments, the design nodes may be linked to one or more specification nodes. In some embodiments, a user may search for a particular design specification by selecting particular design and/or specification nodes.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates a content expansion system, according to an implementation of the disclosure.

FIG. 2A illustrates an image of a design provided in a technical document, according to an implementation of the disclosure.

FIG. 2B illustrates an image generated by the software application based on data extracted by the content expansion system of FIG. 1, according to an implementation of the disclosure.

FIGS. 3A-3C illustrate data used by the content extraction system of FIG. 1, according to an implementation of the disclosure.

FIG. 4 illustrates data types used by the content extraction system of FIG. 1, according to an implementation of the disclosure.

FIG. 5 illustrates graph database structure associated with storing the extracted and newly generated data, according to an implementation of the disclosure.

FIG. 6 illustrates a process of performing a data extraction, according to an implementation of the disclosure.

FIG. 7 illustrates an example computing system that may be used in implementing various features of embodiments of the disclosed technology.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### DETAILED DESCRIPTION

Described herein are systems and methods for extracting data from a technical document in order to generate a file compatible with a plurality of commercially available software applications. The software applications may be used to test the data in order to both verify the accuracy of the extracted data and to generate new designs. Finally, a database may be populated with both the extracted and new data so as to allow users to search for a particular engineering design by specifying query parameters comprising design specifications resulting in more accurate results than those generated by searching technical documents using existing search engines. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As noted above, conducting a patentability search by examining existing technical publications currently requires querying one or more databases that store these publications. This task carries a significant time investment and often fails to provide the inventor with accurate results. First, existing search engines only permit keyword searches and do not allow users to find engineering designs based on particular engineering specifications. Keyword or search term searching generates incomplete results which in turn may cause a user to develop an invention that has already been described. Second, because most technical documents are not compatible with software applications, the user is tasked with identifying relevant information (e.g., technical details such as text and graphical representations) and inputting it into a design software application in order to evaluate and/or make further use of the disclosed design. Thus, even if a desired design is found, the user is burdened with additional steps associated with using the technical publication. Accordingly, various embodiments of the present disclosure are directed to improvements to conducing a search for a technical design related to an inventor's idea that leverages extracting technical data from existing publications and generating new designs based on the extracted data.

In particular, some embodiments may comprise analyzing a technical document to extract one or more design components. For example, design components of a design described in a technical document may be determined by using design component parameters which in turn may be determined by using design component parameter data attributes. In some embodiments, a data file compatible with a particular design software application may be generated from the extracted design components and design component parameters.

In some embodiments, the software application may use the generated data file (i.e., comprising data related to design components and design component parameters) to test or simulate the disclosed design under various conditions. For example, the results of a simulation may include an image comprising a particular number of design components. The simulated image may be compared with the image provided in the technical document to ensure that the design components extracted from the technical document are accurate. Additionally, the software application may generate new design data representing original technical data under a number of simulated conditions.

In some embodiments, the data extracted from the technical document and the new data representing simulated data generated by the software application may be used to populate a database. For example, data representing design components may be stored within design nodes of a design cluster of a graph database, while data representing design component parameters may be stored within specification nodes of a specification cluster. In some embodiments, a user may search for a particular design specification by selecting particular design and/or specification nodes. Because the database is not only populated with data representing existing technical designs but also with new simulated designs, it results in much more expansive data set. Further, by virtue of including new simulated designs, the user is able to use the system to locate improved and/or optimized designs that are not available when using traditional search engines.

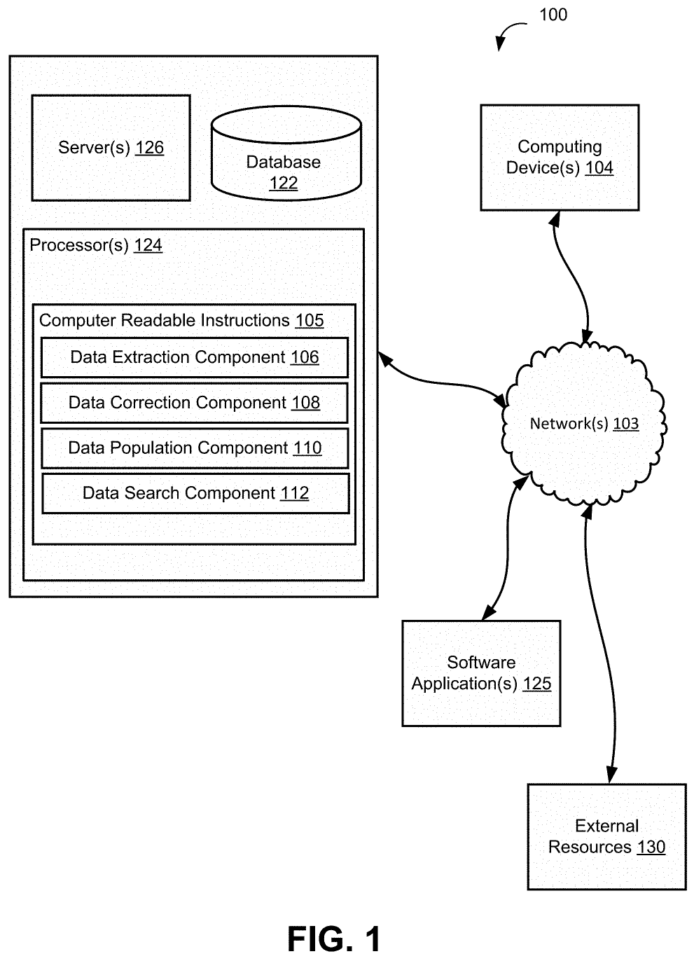

FIG. 1 illustrates an example content expansion system 100 configured in accordance with one embodiment. The content expansion system 100 or components/features thereof may be implemented in combination with, or as an alternative to, other systems/features/components described herein, such as those described with reference to other embodiments and figures. The content expansion system 100 may additionally be utilized in any of the methods for using such systems/components/features described herein. The content expansion system 100 may also be used in various applications and/or permutations, which may or may not be noted in the illustrative embodiments described herein. For instance, content expansion system 100 may include more or less features/components than those shown in FIG. 1, in some embodiments. Moreover, the content expansion system 100 is not limited to the number of components, etc. specifically shown in FIG. 1, although one or more aspects of content expansion system 100 may have particular component constraints in certain embodiments, as these one or more aspects may impact the detection capabilities of content expansion system 100.

In some embodiments, and as shown in FIG. 1, the content expansion system 100 may be configured to populate a database with engineering data obtained from engineering design files generated based on extracted data from one or more technical documents to permit a query of engineering design specifications, as alluded to above. The content expansion system 100 may include AI capabilities implemented by one or more AI controllers (not shown). The controller may be configured to include one or more automated reasoning modules (not shown) comprised of one or more models such as an extraction model and a searching model (not shown). As referred to herein, AI can be described as an automated computer processes that can intelligently leverage data analysis for training itself for further optimizing the processes. ML can be generally considered an application of AI. AI techniques can include various approaches that are used in the area to achieve automated data analysis, such as neural networks, automated reasoning analysis (e.g., satisfiability modulo theories), and so on. AI-based techniques can be used to enhance computer-controlled features of data analysis in a manner that improves data extraction (e.g., identification of a particular design in a technical document) and provides improved searching capabilities that determines design specifications based on user provided search terms.

The content expansion system 100 may include one or more servers 126. For example, the server 126 may be configured to communicate with one or more client computing devices 104 according to a client/server architecture. The users of content expansion system 100 (e.g., product designers) may access the content expansion system 100 via client computing devices(s) 104. Server 126 may include one or more processors 124 configured to execute one or more computer readable instructions 105. In some embodiments, the computer readable instructions 105 may include one or more computer program components. For example, computer program components may include one or more of a data extraction component 106, a data correction component 108, a data population component 110, and a data search component 112, and/or other such components.

In some implementations, client computing devices 104, software application(s) 125, and/or external resources 130 may be operatively linked via one or more electronic communication links. For example, such electronic communication links may be established, at least in part, via a network 103 such as the Internet and/or other networks. It will be appreciated that this is not intended to be limiting, and that the scope of this disclosure includes implementations in which server(s) 126, client computing device(s) 104, software applications 125, and/or external resources 130 may be operatively linked via some other communication media.

In some embodiments, the software application 125 may comprise one or more commercially available software applications used to analyze engineering designs. One such example of an optical design and analysis software application is Zemax by Focus Software, Inc.

The software application 125 may include one or more servers, processors, and/or databases that can store engineering data and generated design simulation data. As alluded to above, the extracted engineering data may be formatted in accordance with software application 125 requirements to allow the content expansion system 100 to use the data with one or more software applications 125. The software application 125 may analyze the uploaded data to verify the accuracy of the data extraction process. Further, by virtue of analyzing the uploaded engineering data, the software application 125 may generate new data and/or designs not included in the original engineering data document, as will be described in detail below.

In some embodiments, external resources 130 may comprise one or more engineering and material science repositories provided by various publications. The material repository may include one or more servers, processors, and/or databases that can store material science related information, e.g., material types, material properties, and similar information provided by one or more material science publications (e.g., Azom). The material science information may be used by the content expansion system 100 during data extraction process, as will be described in detail below.

In some embodiments, as alluded to above, a user may access the content expansion system 100 via a client computing devices 104 via a user interface (not shown). For example, the client computing device 104 may be a desktop computer or a mobile device (e.g., a tablet computing device a cellular phone). The interface may be used to receive and transmit information to the content expansion system 100 via a communication network 103, as explained above.

In some embodiments, the data extraction component 106 may be configured to extract data from one or more technical documents and generate an engineering data file based on the extracted data. In some embodiments, the engineering data file generated from the extracted data may be compatible with one or more software applications (e.g., CAD, Zemax, Cadence, and so on).

In some embodiments, a technical document from which the data may be extracted may include at least one or more of a publication such as a technical paper or an article, a patent, and/or other similar document. In some embodiments, as alluded to earlier, the technical document may comprise a data file in a file format (e.g., a text file, a pdf file, etc.) that may not be readily used by or compatible with a particular software application (e.g., CAD, Zemax, Cadence).

In some embodiments, an engineering data file generated using the extracted data may include one or more data files in a file format compatible with one or more software applications, as explained above. For example, an engineering data file generated from a patent for a lens barrel design may include a file compatible with a software application Zemax.

In some embodiments, the data in the technical document may include engineering data related to a particular engineering design. For example, engineering data may comprise text, equations, and graphical representations such as figures and images. In some embodiments, a particular engineering design may include one or more types of engineering designs. For example, engineering data related to an optical lens design may be included in a technical document.

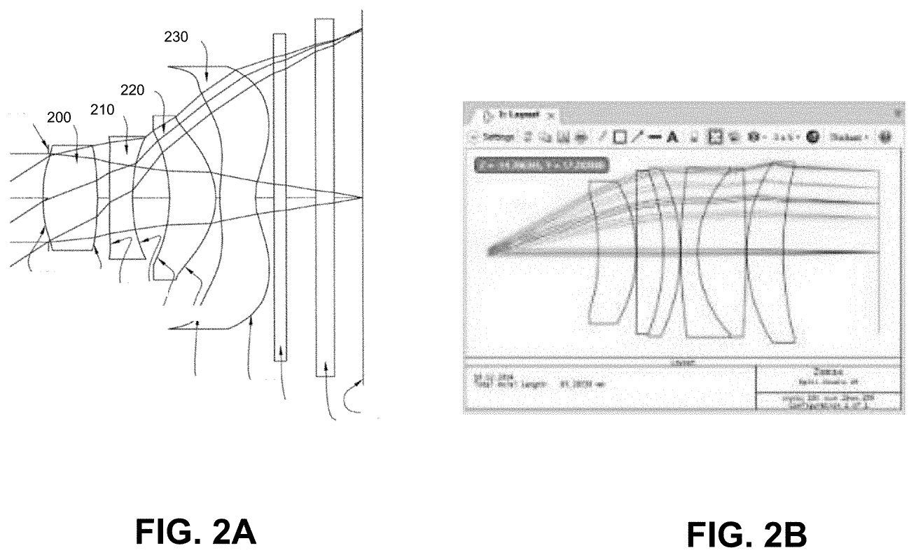

In some embodiments, the engineering data comprising text, equations, and graphical representations may be related to one or more elements or components of an engineering design. For example, and as illustrated in FIG. 2A, individual design components may include a plurality of lenses 200, 210, 220, and 230, in a lens barrel design. In some embodiments, individual design components may be characterized by their properties including material, shape, and so on. For example, an individual lens (e.g., lens 200 illustrated in FIG. 2A) in a lens barrel design may have a particular shape or be associated with a particular material. In some embodiments, individual elements may be described in terms of their relation with the other elements. For example, lenses in a barrel lens may be positioned at particular distances from one another.

In some embodiments, the data extraction component 106 may be configured to extract data from the technical document by converting the technical document into a text file. For example, the text in technical document in a pdf format may be converted to a text file using optical character recognition (OCR) process. In some embodiments, text accompanying graphical representations provided in the technical document may also undergo additional data formatting (e.g., text orientation). For example, text accompanying the images in a technical document may be oriented so as to match the direction of the text in the rest of the document. In some embodiments, the converted technical data may be saved as a new file.

In some embodiments, the data extraction may be dependent on the type of engineering design described in the technical document. For example, data extraction component 106 may be configured to receive input indicating the type of engineering design. In some embodiments, the type of the engineering design may be determined by the system 100 or provided by a user.

In some embodiments, the data extraction component 106 may be configured to identify individual components of a design within the converted technical document based on the type of the engineering design, as alluded to above. For example, a particular design type may be associated with a particular number of components each having a particular property or properties.

In some embodiments, the data extraction may be dependent on the software application for which the engineering data file is generated from the extracted data. For example, extraction component 106 may be configured to receive input indicating the software application engineering design.

In some embodiments, the data extraction component 106 may be configured to identify individual components of a design within the converted technical document based on the type of the software application, as alluded to above. For example, a particular software application may be associated with a particular number of data input fields that may need to be populated with data of a particular data type or characterized by a particular type of information.

In some embodiments, the data extraction component 106 may be configured to analyze the converted design document to identify a set of individual components of a design. For example, the data extraction component 106 may be configured to use information contained in the converted technical document to determine the number of individual design components and their properties.

In some embodiments, the data extraction component 106 may be configured to analyze the converted design document to obtain information related to properties of individual components of a design. In some embodiments, as alluded to earlier, the data extraction component 106 may be configured to be mathematically modeled, for example being modeled using a neural network. Artificial neural networks are a family of technical models based on biological nervous systems, which are used to estimate or approximate functions that depend on a large number of inputs. Neural networks may be represented as a system of interconnected “neurons” which exchange messages between each other. The connections may have numerical weights that can be tuned based on experience, making neural networks adaptive to inputs and capable of machine learning. Artificial neural networks may have a variety of applications, including function approximation, classification, data processing, robotics, and computer numerical control.

In some embodiments, the data extraction component 106 may be trained using an AI model or emulating a neural network to identify one or more design components and or design component parameters. As a general description, training can be an iterative process, where new values for the neural network can be calculated for a respective iteration, by transforming an input vector in relation to the weights.

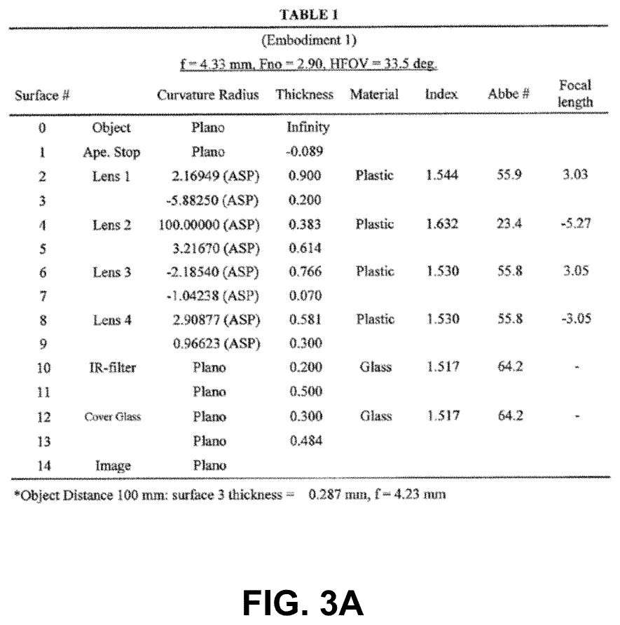

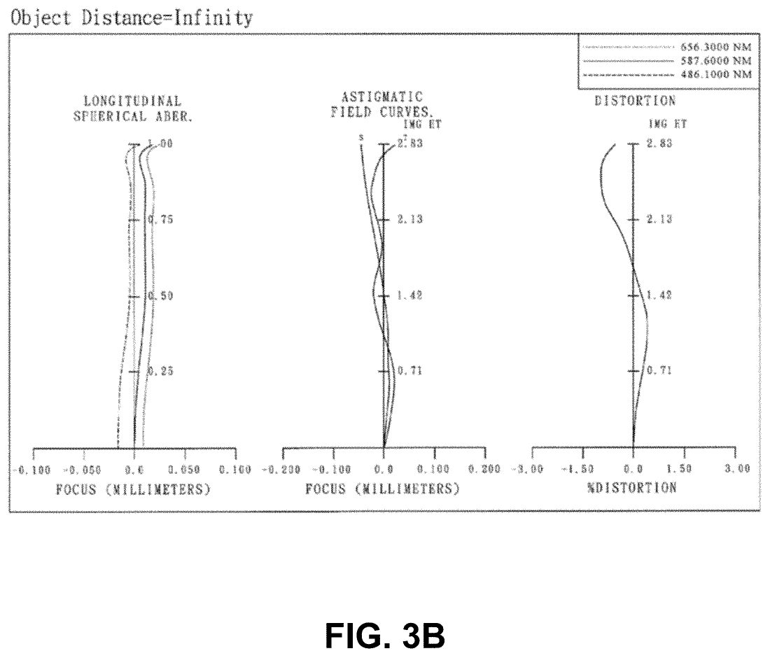

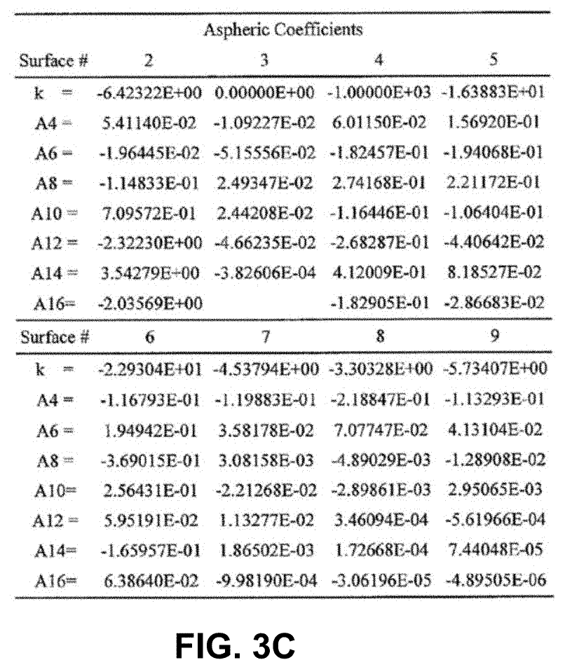

For example, and as illustrated in FIG. 3A, a technical document describing an optical design may include information related to properties of individual lens components (e.g., lenses characterized by a curvature radius, a thickness, a type of material, an index of refraction, an Abbe number, a focal length, and other similar properties) in a lens barrel design.

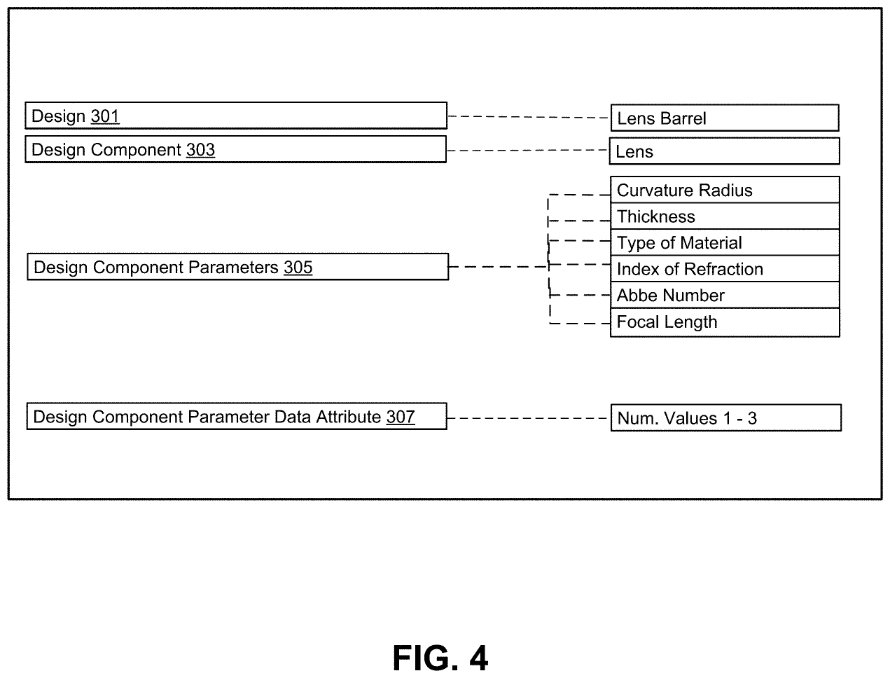

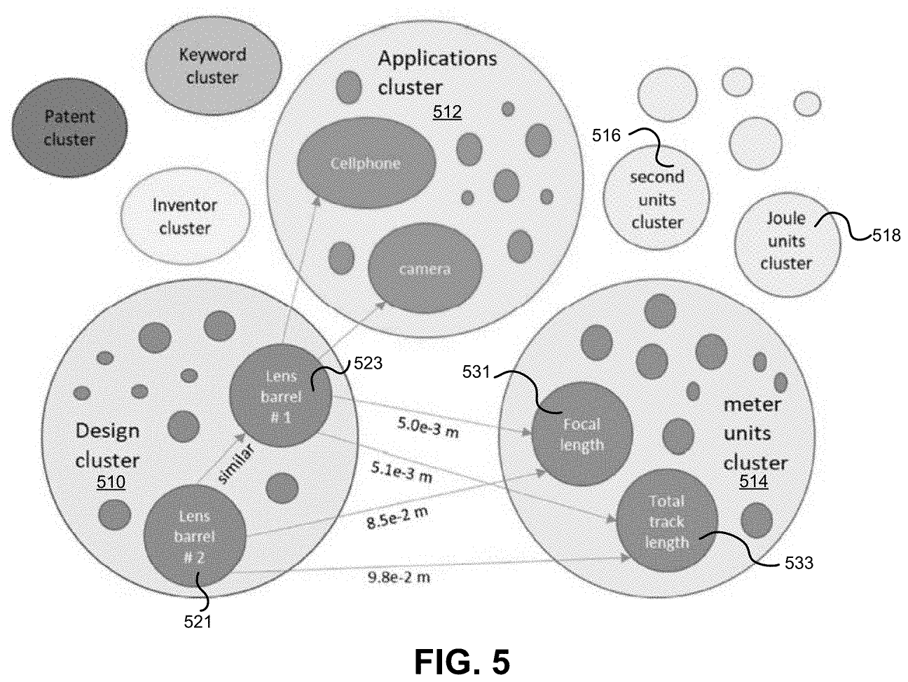

In some embodiments, as illustrated in FIG. 4, the information provided in a technical document may be categorized based on the type of information and/or how one data point may relate to another. For example, a technical document may describe one or more designs (e.g., a design 301 comprising a lens barrel). Each design 301 may have one or more design components (e.g., a design component 303 comprising a lens). Each design component 303 may have one or more design component parameters (e.g., a design component parameter 305 comprising curvature radius, thickness, type of material, index of refraction, Abbe number 319, and focal length). Each design component parameter 305 may have one or more design component parameter data attributes (e.g., a design component parameter data attribute 307 comprising numerical values from 1 to 3).

In some embodiments, the data extraction component 106 may be configured to use the individual design component parameters 305 obtained from the converted design document, as alluded to above, to determine individual design components 303. For example, the data extraction component 106 may identify four lenses (e.g., 200, 210, 220, and 230 illustrated in FIG. 2A) as the design components 303 in a lens barrel design 301 based on design component parameters 305 (e.g., a curvature radius, a thickness, a type of material, an index of refraction, an Abbe number, a focal length, associated with individual lenses, illustrated in FIG. 3A).

In some embodiments, the data extraction component 106 may be configured to determine one or more design component parameters 305 using design component parameter data attributes 307 associated with each design component parameter 305. For example, individual design component parameters 305 may be associated with numerical values having particular number of characters (i.e., design component parameter data attributes 307). By virtue of using these design component parameter data attributes, the extraction component 106 may determine the one or more design components and/or additional design component parameters. For example, a design component parameter data attribute related to an index of refraction may include a numerical value comprising a one digit number, ranging from 1 to 3, followed by a decimal point, and followed by at least one more number (e.g., 1.544). Similarly, a design component parameter data attribute 307 related to a particular design component parameters 305 (e.g., Abbe number) may include a numerical value comprising two digits, followed by a decimal point, and followed by at least one more number (e.g., 55.9).

In some embodiments, the extraction component 106 may confirm values related to design component parameters 305 by obtaining additional data from one or more external resources 130 (e.g., a material science repository), as alluded to earlier. For example, additional information may be obtained for one or more design component parameters to determine validity of other design component parameters that have been determined earlier.

In some embodiments, the data extraction component 106 may be configured to obtain a design component parameter 305 related to a type of material (e.g., glass or plastic). In some embodiments, the data extraction component 106 may obtain information related to properties associated with glass or plastic from the material science repository. For example, such additional information may include an index of refraction, Abbe number and so on. Because different materials will have different indexes of refraction or Abbe numbers, the information related to earlier determined design component parameters may be verified. In essence, the data extraction component 106 may use the material science repository to cross-reference design component parameters to ensure that correct information has been extracted from the technical document. This is to account for the fact that the material information can be provided in many different ways, so the method of extraction needs to account for this in determining the material of each component.

In some embodiments, the data extraction component 106 may be configured to obtain design component parameters 305 that may not be included in the converted technical document as textual information. Rather, the data extraction component 106 may be configured to obtain design component parameters 305 by analyzing graphical representations within the converted technical document. For example, and as illustrated in FIG. 3B, image data related to lens focus and distortion may be analyzed to determine design component parameter related to wavelength. In some embodiments, as alluded to above, the data extraction component 106 may be configured to determine one or more design component parameters using design component parameter data attributes associated with each design component parameter. For example, a design component parameter data attribute 307 related to wavelength may include a numerical value comprising at least a three digit number (before a decimal point) followed by a designation of units (e.g., nm).

In some embodiments, the data extraction component 106 may be configured to determine additional design component parameters 305 by analyzing previously obtained design component parameters 305 and/or by analyzing textual information contained in the converted technical document. For example, and as illustrated in FIG. 3C, the technical document lists aspheric coefficients associated with each surfaces 1-9. However, when no aspheric coefficient is listed the data extraction component 106 may be configured to determined that surface is flat.

In some embodiments, the data extraction component 106 may be configured to obtain design component parameters 305 that may be attributed to all design components 303. For example, the data extraction component 106 may determine that information comprising numerical values does not directly corresponded to a particular design component. Accordingly, that information may attributed to all design components 303 of a design 301 in a technical document.

In some embodiments, the data extraction component 106 may be configured to generate an engineering data file using the extracted data from the converted technical document, as alluded to above. For example, the engineering data file may comprise extracted data related to one or more designs 301 described in the technical document. In some embodiments, the design 301 may comprise one or more design components 303 each comprising of design component parameters 305. In some embodiments, the engineering data file may be saved in a file format corresponding to a software application for which the engineering data file is generated from the extracted data. In some embodiments, the engineering data file may be uploaded into the software application.

In some embodiments, individual engineering data files may be generated for one or more sections within a software application. For example, an engineering data file may be generated for each of the corresponding sections within a Zemax application (e.g., configuration section).

In some embodiments, images from the technical document may be used by the software application. For example, an image of a lens barrel design illustrated in FIG. 2A may be used by Zemax application. In some embodiments, the images may be interpreted by fitting lines or curves to these line drawings in order to extract design information. For example, the image of a lens barrel design illustrated in FIG. 2A comprising a plurality of lenses may be fit using Zernike polynomials to determine the properties of each of the lenses in the design.

In some embodiments, the image interpretation data may be compared with the one or more design component and design component parameters previously obtained. For example, the lens properties determined using Zernike polynomials, as alluded to above, may be compared to lens properties obtained by extracting the data from the technical document (e.g., design component parameter 305 comprising curvature radius, thickness, type of material, index of refraction, Abbe number 319, and focal length). By virtue of comparing the image interpretation data with the previously obtained design components and design component parameters, the system 100 avoids potential errors during data extraction. In some embodiments, upon determining an inconsistency between the image interpretation data and previously obtained design components and design component parameters, the data may be corrected, as described in detail below.

In some embodiments, the data correction component 108 may be configured to obtain one or more design simulation files associated with each of the designs (and corresponding design components comprising design components parameters) extracted from the technical document and uploaded into the software application. In some embodiments, the design simulation files may include design simulation data comprising schematics and/or other images generated based on the extracted data. In some embodiments, the design simulation files may be compared to image within the technical document. By virtue of comparing the images within the technical document to the design simulation allows the system to ensure that the extracted data corresponds to the correct design component and/or design component parameter.

For example, data extracted from a patent related to a lens barrel design may be uploaded into a Zemax application used to simulate the design by ray tracing. The Zemax application may generate new images of the lens barrel design by performing test and/or simulations using the design component and design component parameters obtained by the data extraction component 106, alluded to above. The new images generated by Zemax, illustrated in FIG. 2B may be compared to original lens barrel design illustrated in FIG. 2A.

In some embodiments, upon determining that the images within the technical document are different from the images generated by the software application during a design simulation, the data correction component 108 may be configured to identify one or more component and/or component parameter that are not accurately represented. In some embodiments, the data correction component 108 may be configured to adjust values associated with the one or more component and/or component parameters identify as inaccurate and obtain a subsequent design simulation data. In some embodiments, the data correction component 108 may be configured to perform multiple compare/correct iterations between the images in the technical document and the images generated by the software application during a design simulation related to individual designs described in the technical document. In some embodiments, each result of the image comparison may be assigned a value representing accuracy of the comparison. For example, a value of 0.5 may indicate that only fifty percent of elements in the simulated design image has a corresponding counterpart in the image provided by the technical document In some embodiments, the data correction component 108 may be configured to determine that the image generated by the software application during a design simulation is satisfactory upon obtaining the value above a particular threshold.

In some embodiments, the data correction component 108 may be may be trained using an AI model or emulating a neural network to the image generated by the software application during a design simulation is satisfactory.

In some embodiments, upon verifying the images generated by the software application during a design simulation, as alluded to above, the software application may generate one or more output files representing design simulations and/or tests under various conditions. For example, the one or more output files may include graphical representations (e.g., plots) or numerical data.

In some embodiments, the data population component 110 may be configured to store the images and/or associated data extracted from the technical document in one or more data stores (e.g., database 122) within that system 100. In some embodiments, the data population component 110 may be configured to store the output files comprising images and/or data that have been generated by the software application based on the extracted data, as alluded to above. By populating the data store with information extracted from the technical document along with new information generated by the software application allows users to conduct more thorough and comprehensive searches. That is because the data store may be populated with multiple variations of a particular design.

In some embodiments, the data store may comprise a graph database. For example, and as illustrated in FIG. 5, extracted images and data from a technical document may be stored within a data store comprising graph structures for semantic queries with nodes, edges, and properties to represent and store data.

In some embodiments, the data extracted from the technical paper may be stored within one or more cluster. In some embodiments, the data extracted from the technical paper may be grouped within a particular cluster. For example, individual design components of a design may be stored within deign nodes of a design cluster. For example, lens barrel design component 1 and lens barrel design component 2 may be stored within design nodes 521 and 523, respectively.

In some embodiments, design component parameters may be stored within specification nodes within one or more clusters. For example, focal length and total track length may be stored within specification nodes 531 and 533, respectively.

In some embodiments, specification nodes having numerical values may be grouped by their units and connected by edges that are labeled with numerical values. In some embodiments, design nodes in a design cluster 510 may be linked to one or more nodes in various other clusters (e.g., application cluster 512 and meter units cluster 514). For example, second units cluster 516 and Joule units cluster 518 show specification nodes that have a numerical value as a label on the edge linking it to the design node.

In some embodiments, the output files generated by the software application may be added to the graph database along with the edges of a design cluster storing the data extracted from the technical document.

In some embodiments, upon populating the data store 122 with extracted and newly generated data, as alluded to above, the data search component 112 may be configured to allow a user to conduct a query using engineering specifications. For example, the data search component 112 may be configured to permit a user to specify one or more search parameters during a query. By virtue of being able to specify the search parameters permits the user to formulate a query more narrowly resulting in a more tailored search result

In some embodiments, the data search component 112 may be configured to obtain one or more search terms relating to one or more design specifications. For example, a design specification may refer to one or more functional aspects of the design that users may describe with one or more particular keywords. In some embodiments, the data search component 112 may be configured to obtain a design specification corresponding to the keyword provided by the user. For example, the data search component 112 may be configured to be trained using an AI model or emulating a neural network to identify one or more design specification corresponding to a particular keyword.

In some embodiments, the data search component 112 may be configured to obtain one or more specification nodes as a query parameter. For example, a user may specify a particular specification node. In some embodiments, if a specification node does not have a numerical value, the data search component 112 may be configured to include all design nodes linked to that specification node during the search. Alternatively, if a specification node does have a numerical value, data search component 112 may be configured to only include design nodes that are linked with edges labeled with a number that lies within the desired range of values for that specification node.

In some embodiments, the data search component 112 may be configured to obtain additional one or more specification nodes out of the specification nodes linked to the previously included design nodes, as a query parameter. For example, a user may specify a particular specification node. In some embodiments, if a specification node does not have a numerical value, the data search component 112 may be configured to exclude all design nodes that are not linked to the selected specification nodes. Alternatively, if a specification node does have a numerical value, data search component 112 may be configured to exclude design nodes with edge labels outside of the desired range of values for that specification node.

In some embodiments, the data search component 112 may be configured to continue obtaining specification nodes until a particular number of selected design nodes remains. For example, a user may continue to specify a particular specification node.

In some embodiments, some specification nodes may not be actively obtained (e.g., specified by a user). Rather, some specification nodes may become selected automatically. For example, a specification node that is equivalent to another set of specification nodes that have already been selected may be selected. For example, because f-number is equal to the focal length divided by the entrance pupil diameter, a lens may be equivalently specified using f-number and focal length as it can using entrance pupil diameter and focal length. That is, by if two of the three are specified, the remaining one is specified automatically.

In some embodiments, the data search component 112 may be configured to generate a result comprising a number of design nodes that may or may not meet all requirements of the user, depending on whether the user sufficiently specified the design node.

In some embodiments, upon the data search component 112 generating a result that does not meet the requirements of the user, the user may continue to further specify the design nodes even when there are no remaining selected design nodes. For example, the data search component 112 may obtain a specification node and an input corresponding to a range of values (e.g., in the event the specification node has a numerical value). In some embodiments, this process may be repeated for a as many new specification nodes as may be desired by the user.

In some embodiments, the data search component 112 may be configured to generate one or more new design nodes linked to one of the remaining design nodes in the previous step with an edge labeled “similar”. In some embodiments, the software application files corresponding to the similar design nodes are opened and new design optimization is carried out using a merit function that takes into account all specifications to generate new designs that can meet user requirement). In some embodiments, the specifications for the new designs may be saved within the data store 122. By virtue of generating new designs using existing designs, the system 100 increases the number of potential designs available.

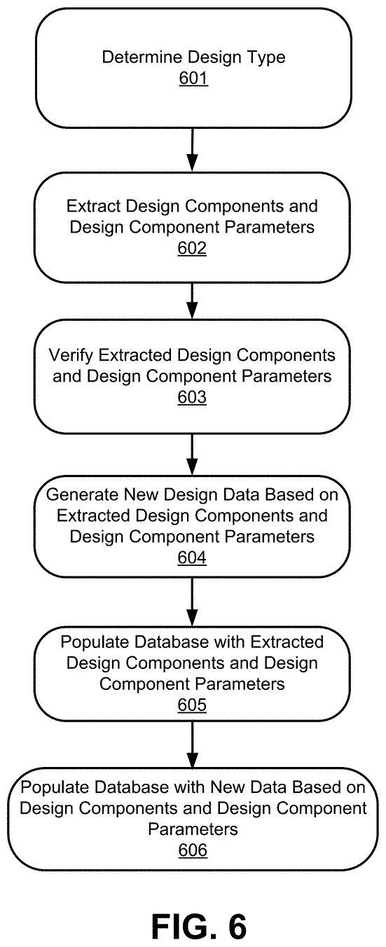

FIG. 6 illustrates a flow chart describing various processes that can be performed in order to extract data from a technical document, in accordance with another embodiment. For example, at operation 601, the type of an engineering design described in a technical document may be determined. Upon determining the design type, the design components and design component parameters of a design may be extracted from the technical document, at operation 602.

The design components and design component parameters may be verified by simulating the design comparing the extracted design components and design component parameters in a software application, at operation 603.

Upon verifying the design, the software application may generate new designs based on extracted design components and design component parameters, at operation 604.

At an operation 605 and 606, the extracted design components and design component parameters and the new designs may be used to populate a database.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The described operations, such as those illustrated in FIGS. 1-6 and described above, may be accomplished using some or all of the system components described in detail herein and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting. It is to be expressly understood that the drawings are for the purpose of illustration and description only and are not intended as a definition of the limits of the invention.

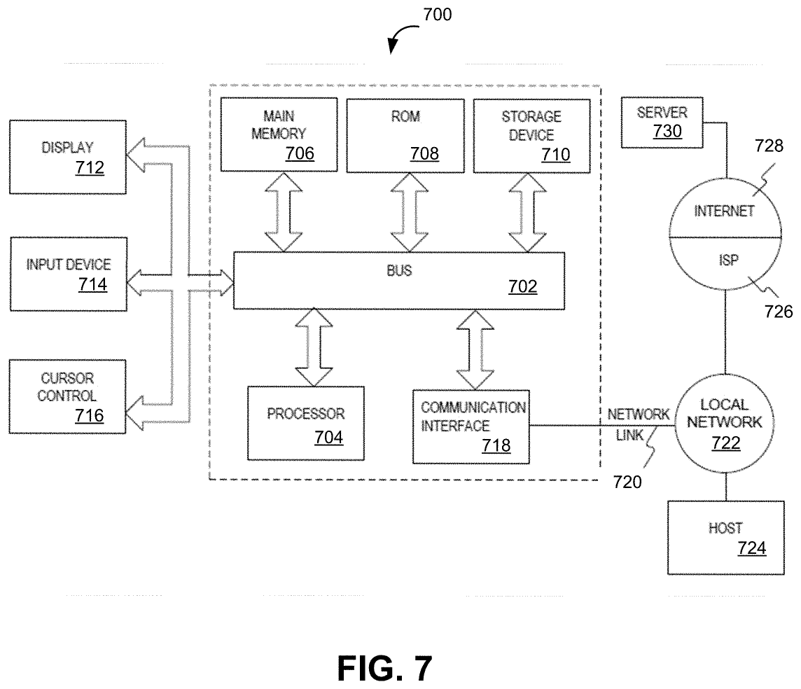

FIG. 7 depicts a block diagram of an example computer system in which any of the embodiments described herein may be implemented. The various components illustrated in FIGS. 1-6 may be implemented according to the computer system 700. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 700 may include a user interface component to implement a GUI that may be stored in a mass storage device as executable software codes that are executed by the computing device(s). This and other components may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicate with a WAN). Wireless links may also be implemented. In any such implementation, communication interface 718 sends and receives electrical, electromagnetic or optical signals that carry digital data streams representing various types of information.

A network link 720 typically provides data communication through one or more networks to other data devices. For example, a network link may provide a connection through local network to a host computer 724 or to data equipment operated by an Internet Service Provider (ISP) 726. The ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server 730 might transmit a requested code for an application program through the Internet 728, the ISP 726, the local network 722 and the communication interface 718. The received code may be executed by processor 704 as it is received, and/or stored in storage device 710, or other non-volatile storage for later execution.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method of expanding content in a document, the method comprising:
obtaining a document comprising design specifications of a design; and
extracting a first set of numerical parameters from the document into a file;
wherein the file is compatible with a design software application.

2. The method of claim 1, further comprising:
using the design software application to generate new data comprising a second set of numerical parameters;
wherein the new data was not present in the document.

3. The method of claim 2, wherein the second set of numerical parameters correlates with the design specifications provided in the document.

4. The method of claim 2, wherein the new data includes a new design based on parametric optimization of the design specifications provided the document.

5. The method of claim 4, wherein the parametric optimization is done using a merit function;
wherein the merit function is based on a combination of all the design specifications.

6. The method of claim 2, further comprising:
uploading the file and the new data to a database; and
creating one or more links between the document, the file, and the new data.

7. A computer implemented method of specifying a design, comprising:
organizing one or more design specifications extracted from a technical document in a graph database by storing the one or more design specifications in one or more design nodes;
linking the one or more design nodes to one or more specification nodes using design node edges;
wherein the one or more specification nodes are grouped in clusters, each cluster corresponding to units of numerical data provided in the specification nodes; and
wherein design node edges comprise labels specifying a numerical value of the numerical data provided in the specification node linked to the design node.

8. The method of claim 7, further comprising steps of:
selecting a first specification node and design nodes linked to it;
unselecting design nodes comprising design node edges having labels outside of a range of values; and
selecting a second specification node and unselecting design nodes not linked to the second specification node.

9. The method of claim 7, wherein the steps are repeated until a first set of design nodes is selected.

10. The method of claim 7, wherein the steps are repeated and a new design node is created;
wherein no design nodes are selected.

11. The method of claim 9, further comprising:
linking the new design node to an existing design node with a label; and
linking the new design node to specification nodes to which the existing design node is linked to;
wherein the label indicates that the one or more design specifications stored within the new design node is similar to the one or more design specifications stored within the existing design node.
